(19) United States
(12) Patent Application Publication
(10) Pub. No.: US 2011/0279792 A1
(43) Pub. Date: Nov. 17, 2011

(54) PROJECTION DISPLAY DEVICE

(75) Inventors: So SUZUKI, Osaka-city (JP); Toshimasa KANBARA, Kishiwada-city (JP)

(73) Assignee: SANYO ELECTRIC CO., LTD., Moriguchi-city (JP)

(21) Appl. No.: 13/107,237

(22) Filed: May 13, 2011

(30) Foreign Application Priority Data
May 13, 2010 (JP) 2010-111110

(51) Int. Cl. G03B 21/14

(52) U.S. Cl. 353/119

(57) ABSTRACT

A projection display device is provided with an adjustable leg which adjusts an inclination of the main body cabinet. The adjustable leg includes a leg portion whose projection amount from the bottom surface is changed, and a foot portion which is contacted with an installation plane of the projection display device, the adjustable leg being expandable and contractible from a reference length position at which the main body cabinet is placed in parallel to the installation plane. The bottom surface of the main body cabinet has a recess portion which is configured so as to guide in and out of the foot portion, as the adjustable leg is contracted and expanded. The foot portion has an index portion which is set to the same height as the height of the bottom surface with respect to the installation plane, when the adjustable leg is positioned at the reference length position.

This application claims priority under 35 U.S.C. Section 119 of Japanese Patent Application No. 2010-111110 filed May 13, 2010, entitled “PROJECTION DISPLAY DEVICE”. The disclosure of the above application is incorporated herein by reference.

### BACKGROUND OF THE INVENTION

1. Field of the Invention

The present invention relates to a projection display device for modulating light from a light source by an imager, and enlarging and projecting the modulated light onto a projection plane.

2. Disclosure of Related Art

Conventionally, a projection display device (hereinafter, called as a “projector”) such as a liquid crystal projector is provided with an expandable and contractible i.e. adjustable leg on a bottom surface of a main body cabinet. The inclination of the main body cabinet is changeable by expanding or contracting the adjustable leg. Thus, the height or the inclination of an image projected on a screen is adjusted.

In the projector having the above arrangement, for instance, when the main body cabinet is placed in parallel to the installation plane of the projector, the adjustable leg is set to a maximally contracted state; and as the adjustable leg is expanded from the maximally contracted state, the main body cabinet is inclined in such a direction that a front portion thereof is raised. Then, an image projected on a screen is shifted upward.

The projector having the above arrangement may be configured such that the adjustable leg is not only expandable but also contractible from a state where the main body cabinet is placed in parallel to the installation plane. With such a configuration, it is possible to incline the projector obliquely upward or obliquely downward from a state where the main body cabinet is placed in parallel to the installation plane.

The projector may be used in various installation environments. The projector may be inclined not only forward and rearward but also leftward and rightward depending on a protruding state of the adjustable leg. It is difficult to adjust the height and the like of a projected image from the inclined state in which the projector was used last time when the projector is used next time. In view of the above, it is desirable to return the adjustable leg to an initial state, in other words, a state where the main body cabinet is placed in parallel to the installation plane, before use of the projector. The above arrangement makes it possible to easily adjust the height and the like of a projected image depending on a use condition, while using the initial position of the projector as a reference.

In particular, in a so-called short focus projector which is configured to reflect light from a projection lens on a reflection mirror to project the reflected light obliquely upward, the distance between the projector and the projection plane is short. As a result, a slight change in forward/rearward or leftward/rightward inclination of the main body cabinet may cause a change in the upward/downward position or the leftward/rightward inclination of a projected image. Therefore, if the height position of the adjustable leg is displaced from a position where the main body cabinet is placed in parallel to the installation plane in an initial state, an initially projected image is likely to be inclined leftward or rightward when the projector is placed on a horizontal installation plane, which makes it difficult to adjust the upward/downward position or the leftward/rightward inclination of a projected image to be projected thereafter. Thus, in a short focus projector, it is particularly desirable to accurately return the adjustable leg to a position where the main body cabinet is placed in parallel to the installation plane, in an initial state of the projector.

In an arrangement that the main body cabinet is placed in parallel to the installation plane when the adjustable leg is in a maximally contracted state, it is possible to easily return the main body cabinet to a parallel state by maximally contracting the adjustable leg.

However, in an arrangement that the main body cabinet is placed in parallel to the installation plane when the adjustable leg is somewhere in the middle of an expansion/contraction range, it is difficult to return the main body cabinet to a parallel state, because there is no definite reference for the projection amount of the adjustable leg.

### SUMMARY OF THE INVENTION

A projection display device according to a main aspect of the invention is provided with a main body cabinet, and an adjustable leg which is disposed on a bottom surface of the main body cabinet, and adjusts an inclination of the main body cabinet. In this arrangement, the adjustable leg includes a leg portion whose projection amount from the bottom surface is changed, and a foot portion which is formed at a lead end of the leg portion and is contacted with an installation plane of the projection display device, the adjustable leg being expandable and contractible from a reference length position at which the main body cabinet is placed in parallel to the installation plane. Further, the bottom surface of the main body cabinet has a recess portion which is configured so that the foot portion going in and out of the recess portion as the adjustable leg is contracted and expanded. Furthermore, the foot portion has an index portion which is set to the same height as the height of the bottom surface with respect to the installation plane, when the adjustable leg is positioned at the reference length position.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams (perspective views) showing an external construction of a projector embodying the invention.

FIG. 2 is a diagram (bottom view) showing an external construction of the projector as the embodiment.

FIG. 3 is a diagram showing an internal structure of the projector as the embodiment.

FIG. 4 is a diagram schematically showing an arrangement of a projection optical unit in the embodiment.

FIGS. 5A and 5B are diagrams for describing a structure of a main body cabinet for holding adjustable legs in the embodiment.

FIGS. 6A and 6B are diagrams for describing an arrangement of adjustable legs and a fixed leg in the embodiment.

FIGS. 7A and 7B are diagrams for describing the arrangement of adjustable legs and a fixed leg in the embodiment.

FIGS. 8A to 8C are diagrams for describing a movement of the position of an image in expanding or contracting the adjustable legs in the embodiment.

FIGS. 9A and 9B are diagrams for describing an arrangement of adjustable legs and a fixed leg as a modification of the embodiment of the invention.

The drawings are provided mainly for describing the present invention, and do not limit the scope of the present invention.

### DESCRIPTION OF PREFERRED EMBODIMENTS

In the following, an embodiment of the invention is described referring to the drawings.

In the embodiment, a lower surface 133a, an upper surface 133b, and a line 133c of a tab portion 133 correspond to an “index portion” in the claims. The description regarding the correspondence between the claims and the embodiment is merely an example, and the claims are not limited by the description of the embodiment.

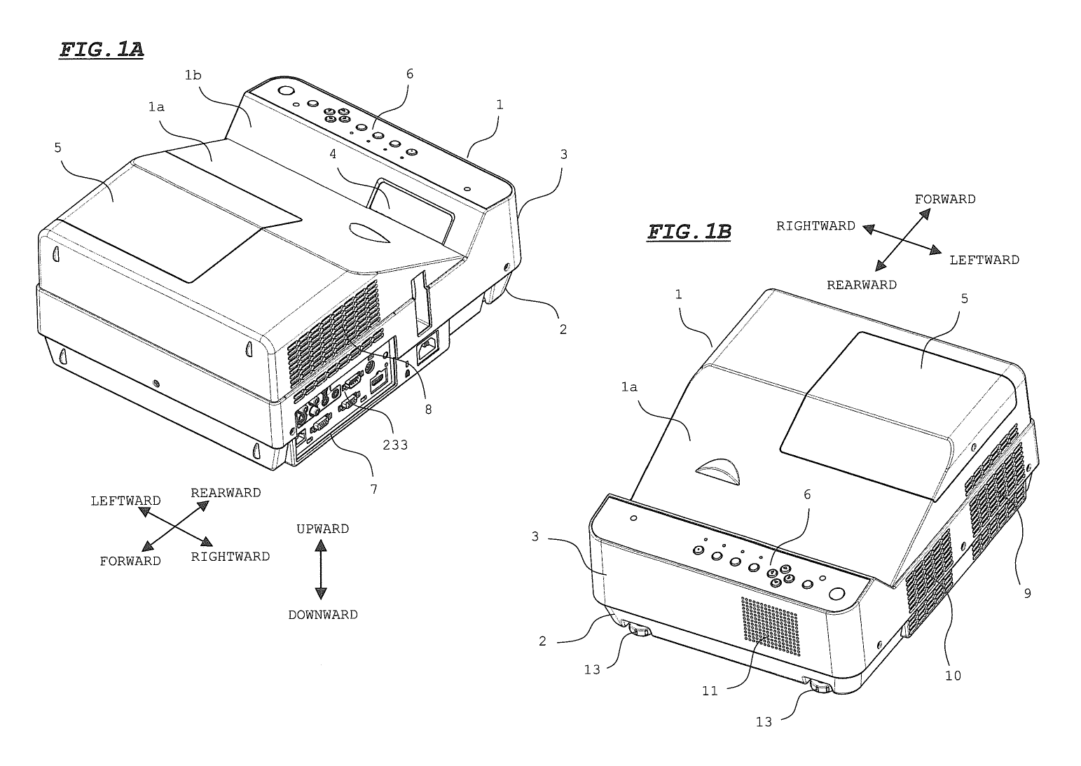

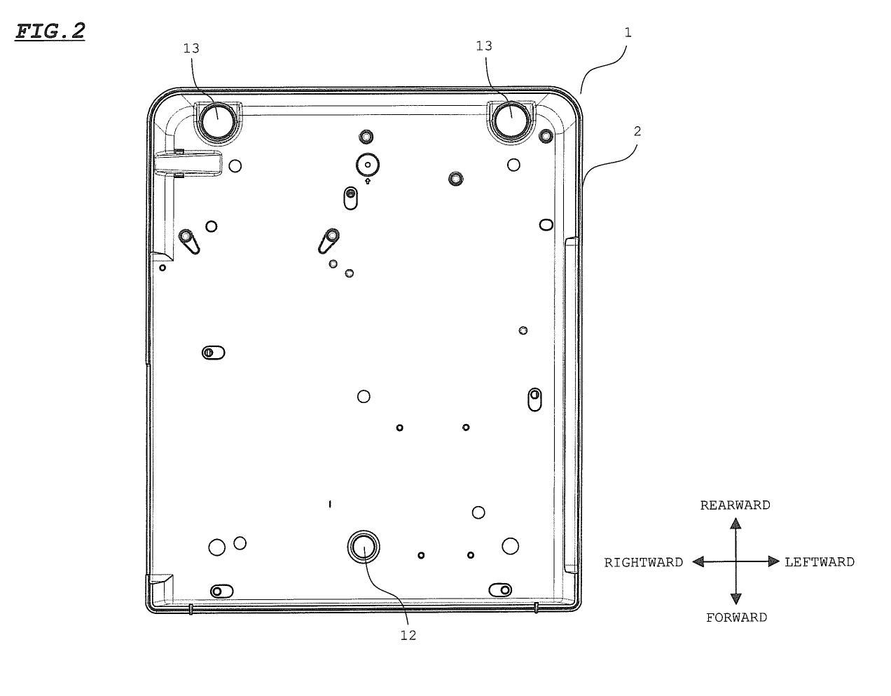

FIGS. 1A, 1B and FIG. 2 are diagrams showing an external construction of a projector embodying the invention. FIG. 1A is a perspective view of the projector when viewed from a front side, and FIG. 1B is a perspective view of the projector when viewed from a rear side. FIG. 2 is a bottom view of the projector. To simplify the description, arrows respectively indicating forward, rearward, leftward, and rightward directions are depicted in FIGS. 1A, 1B and FIG. 2. Hereinafter, the arrows indicating forward, rearward, leftward, and rightward directions are depicted in the same manner as above in the other drawings, as necessary.

The projector of the embodiment is a so-called short focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is placed on the lower cabinet 2 from above.

A top surface of the main body cabinet 1 is formed with a first slope 1a inclined downward and rearward, and a second slope 1b continuing from the first slope 1a and inclined upward and rearward. The second slope 1b faces obliquely upward and forward, and a projection port 4 is formed in the second slope 1b. Image light emitted obliquely upward and forward through the projection port 4 is enlarged and projected onto a screen disposed in front of the projector.

Further, the top surface of the main body cabinet 1 is formed with a lamp cover 5. The top surface of the main body cabinet 1 is formed with a lamp opening for use in exchanging a lamp unit, and a filter opening for use in exchanging a filter disposed in a fan unit for cooling the lamp unit. The lamp cover 5 is a cover for covering the lamp opening and the filter opening. Further, the top surface of the main body cabinet 1 is provided with an operation portion 6 constituted of a plurality of operation keys.

A terminal port portion 7 is formed in a right surface of the main body cabinet 1. A terminal panel 233 having various terminals such as AV terminals is attached to the terminal port portion 7. The terminal panel 233 constitutes a part of a control circuit unit to be described later. Audio Visual (AV) signals such as an image signal and an audio signal are inputted and outputted to and from the projector through the AV terminals. Further, an air inlet 8 is formed in the right surface of the main body cabinet 1 at a position above the terminal port portion 7. The air inlet 8 is constituted of multitudes of slit holes, and external air is drawn into the main body cabinet 1 through the air inlet 8.

A first air outlet 9 and a second air outlet 10 are formed in a left surface of the main body cabinet 1. Each of the first and second air outlets 9, 10 is constituted of multitudes of slit holes, and air inside the main body cabinet 1 is discharged to the outside of the projector through the first and second air outlets 9, 10. Further, a sound output port 11 is formed in a rear surface of the main body cabinet 1. Sounds in accordance with images are outputted through the sound output port 11 at the time of image projection.

Referring to FIG. 2, a fixed leg 12 is disposed in the middle of a front portion on a bottom surface of the main body cabinet 1, and two adjustable legs 13 are disposed at a rear end thereof. By expanding or contracting the two adjustable legs 13 up and down, it is possible to adjust the inclination of the main body cabinet 1 in forward/rearward directions and leftward/rightward directions. Thus, it is possible to adjust the upward/downward position and the leftward/rightward inclination of an image projected on a screen.

The projector of the embodiment may be installed in a suspended state from a ceiling with the main body cabinet 1 being upside down, other than an installation manner that the bottom surface of the main body cabinet 1 is placed on an installation plane such as a desk surface or a floor surface. Further, a front surface of the main body cabinet 1 is a flat surface without the terminal panel 233 and the air inlet 8. Accordingly, it is possible to install the projector of the embodiment in such a manner that the front surface of the main body cabinet 1 is placed on an installation plane. In this case, an image is projected on the installation plane itself.

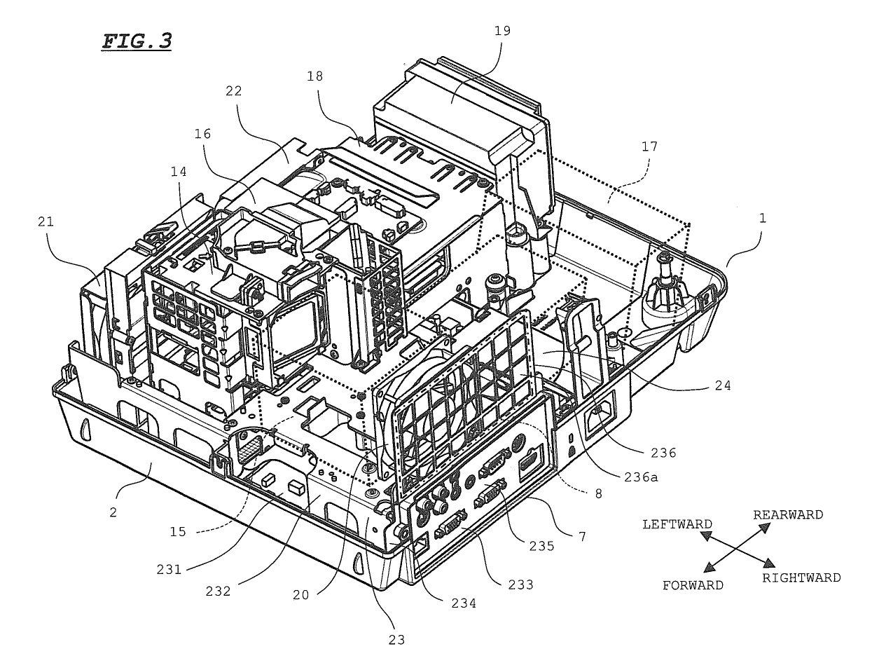

FIG. 3 is a diagram showing an internal structure of the projector. FIG. 3 is a perspective view showing a state that the upper cabinet 3 is detached, when viewed from a front side. To simplify the description, in FIG. 3, an imager unit 15 and a projection optical unit 17 are indicated by the dotted lines. Further, the position of the air inlet 8 is indicated by the one-dotted chain line.

Referring to FIG. 3, a lamp unit 14, and the imager unit 15 for modulating light from the lamp unit 14 to generate image light are disposed on a front portion of the lower cabinet 2.

The lamp unit 14 is constituted of a light source lamp, and a lamp holder for holding the light source lamp; and is configured so as to be detachably attached from above. A fan unit 16 is disposed behind the lamp unit 14. The fan unit 16 supplies external air (cooling air) drawn through the air inlet 8 to the light source lamp to cool the light source lamp. The lamp holder is formed with an air duct for guiding the cooling air from the fan unit 16 to the light source lamp.

The imager unit 15 includes a color wheel and a Digital Micromiror Device (DMD). The color wheel separates white light from the light source lamp into light of respective colors such as red, green, blue in a time-sharing manner. The DMD modulates the light of the respective colors emitted from the color wheel based on an image signal.

The projection optical unit 17 is disposed at a rear position of the imager unit 15. The projection optical unit 17 enlarges image light generated by the imager unit 15, and projects the enlarged image light onto a projection plane such as a screen.

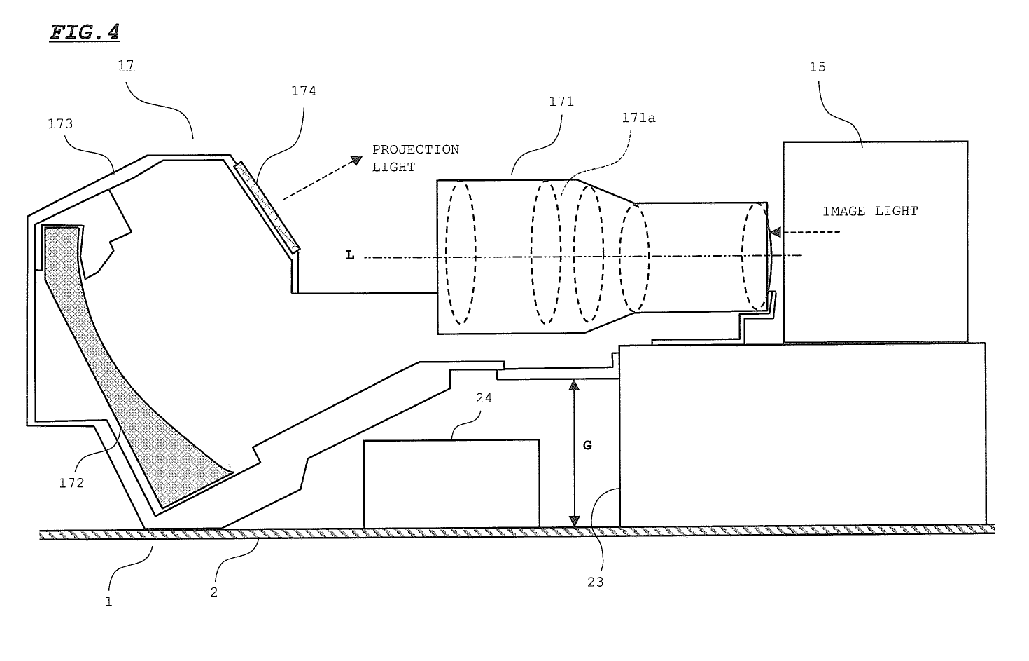

FIG. 4 is a diagram schematically showing an arrangement of the projection optical unit 17. In FIG. 4, the imager unit 15, a control circuit unit 23, and a noise filter unit 24 are schematically shown, in addition to the projection optical unit 17.

The projection optical unit 17 is constituted of a projection lens unit 171, a reflection mirror 172, and a housing 173 for housing the projection lens unit 171 and the reflection mirror 172. The projection lens unit 171 has a plurality of lenses 171a. The reflection mirror 172 is a curved mirror or a free curved mirror.

As shown in FIG. 4, image light emitted from the imager unit 15 is entered into the projection lens unit 171 at a position shifted from the optical axis L of the projection lens unit 171 in a direction toward the top surface of the main body cabinet 1. The entered image light receives a lens action by the projection lens unit 171, and is entered into the reflection mirror 172. Thereafter, the projection angle of the image light is expanded by the reflection mirror 172, and the image light is projected onto a projection plane (screen) via a light ray passage window 174.

As described above, image light is entered into the projection lens unit 171 at a position shifted from the optical axis L of the projection lens unit 171 in a direction toward the top surface of the main body cabinet 1. In view of this, the reflection mirror 172 is disposed at a position shifted from the optical axis L of the projection lens unit 171 toward the bottom surface of the main body cabinet 1. Here, the reflection mirror 172 has a reflection surface larger than the lens surface of each lens 171a constituting the projection lens unit 171. Accordingly, the shift amount of the reflection mirror 172 with respect to the optical axis L of the projection lens unit 171 is relatively large. Consequently, there is defined a relatively large space G between a lower surface of the projection lens unit 171 and the bottom surface of the main body cabinet 1 (lower cabinet 2). The space G is defined from the position where the projection lens unit 171 is disposed to the position where the imager unit 15 is disposed.

Referring back to FIG. 3, a power source unit 18 is disposed behind the fan unit 16. The power source unit 18 is provided with a power source circuit to supply electric power to each electric component of the projector. A speaker 19 is disposed behind the power source unit 18. Sounds outputted through the speaker 19 are released to the outside through the sound output port 11.

A DMD cooling fan 20 is disposed on the right of the imager 15. The DMD cooling fan 20 supplies external air drawn through the air inlet 8 to the imager unit 15 so as to cool the DMD.

A lamp exhaust fan 21 is disposed on the left of the lamp unit 14. The lamp exhaust fan 21 draws the air that has cooled the light source lamp, and discharges the air to the outside through the first air outlet 9.

A power source exhaust fan 22 is disposed on the left of the power source unit 18. The power source exhaust fan 22 draws warmed air inside of the power source unit 18, and discharges the warmed air to the outside through the second air outlet 10. By flowing the air from the inside of the power source unit 18 to the power source exhaust fan 22, fresh external air is supplied into the power source unit 18 through the air inlet 8.

As shown in FIG. 3 and FIG. 4, in the projector of the embodiment, the control circuit unit 23 and the noise filter unit 24 are disposed in the space G defined below the projection lens unit 171 and the imager unit 15.

The noise filter unit 24 is provided with a circuit board mounted with a noise filter and a fuse thereon, and supplies electric power inputted from a commercial AC power source to the power source unit 18 after noise removal.

The control circuit unit 23 includes a control circuit board 231, a holder 232 for holding the control circuit board 231, the terminal panel 233, and a fixing board 234 for fixing the terminal panel 233.

A control circuit for controlling various driving components such as a light source lamp and a DMD is mounted on the control circuit board 231. Further, various terminals 235 are mounted on the control circuit board 231.

The terminal panel 233 is formed with various openings of the shapes in accordance with the shapes of the terminals 235. The terminals 235 are exposed to the outside through the openings. Although not illustrated, the fixing board 234 is formed with openings through which the terminals 235 pass, as well as the terminal panel 233.

The fixing board 234 is made of a metal material, and a shielding portion 236 is formed on an upper portion thereof. The shielding portion 236 is formed with multitudes of openings 236a, and a metal mesh (not shown) is attached to each of the openings 236a. The shielding portion 236 is disposed on the inside of the air inlet 8 to block electromagnetic wave from leaking to the outside through the air inlet 8. External air drawn through the air inlet 8 is supplied to the inside of the main body cabinet 1 through the openings 236a.

Next, the adjustable legs 13 and the fixed leg 12 provided on the bottom portion of the main body cabinet 1 are described in detail.

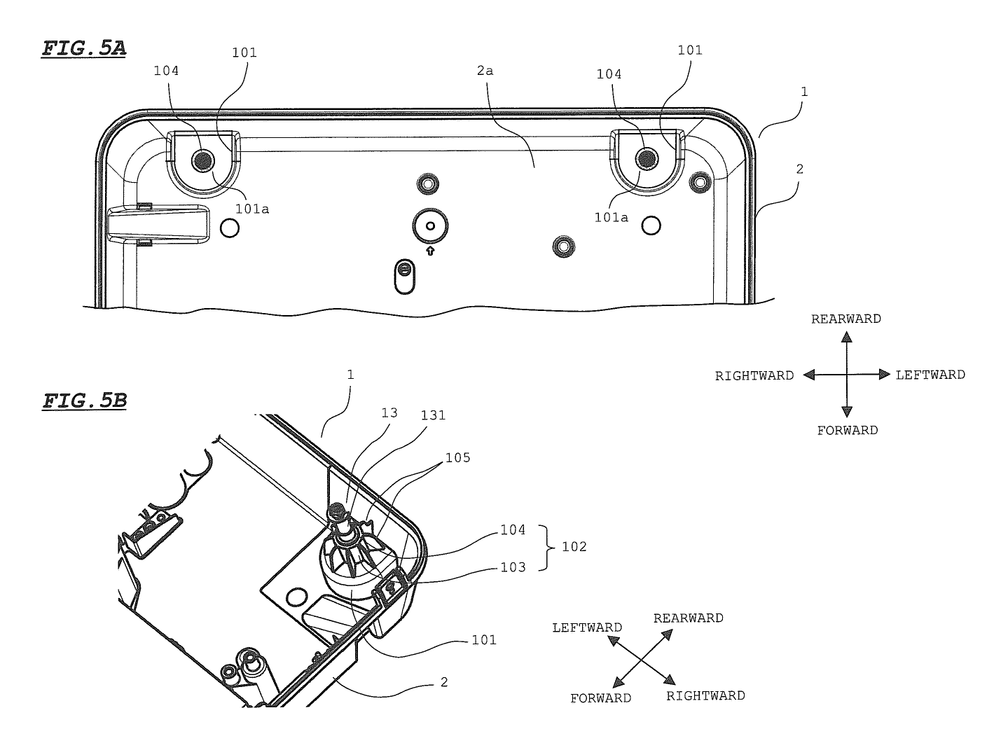

FIGS. 5A and 5B are diagrams for describing a structure of the main body cabinet 1 for holding the adjustable legs 13. FIG. 5A is a bottom view of a rear end of the main body cabinet 1 in a state that the adjustable legs 13 are detached. FIG. 5B is a perspective view of a right rear corner portion of the main body cabinet 1 in a state that the upper cabinet 3 is detached.

As shown in FIG. 5A, a bottom surface 2a of the main body cabinet 1 (lower cabinet 2) is formed with a recess portion 101 on both of left and right sides on a rear end thereof. The recess portion 101 has a U-shaped outer perimeter and is opened outside toward the rear surface of the main body cabinet 1. A bottom surface of the recess portion 101 is formed with an insertion hole 101a in which a leg portion 131 (see FIG. 5B) of the adjustable leg 13 is received.

As shown in FIG. 5B, a back surface of the recess portion 101 is formed with a holding portion 102 for holding the leg portion 131. The holding portion 102 is constituted of a cylindrical portion 103 communicating with the insertion hole 101a, and a nut 104 engaged in the cylindrical portion 103. A plurality of radial ribs 105 are formed on the outer surface of the cylindrical portion 103 to reinforce the cylindrical portion 103. The nut 104 has female threads.

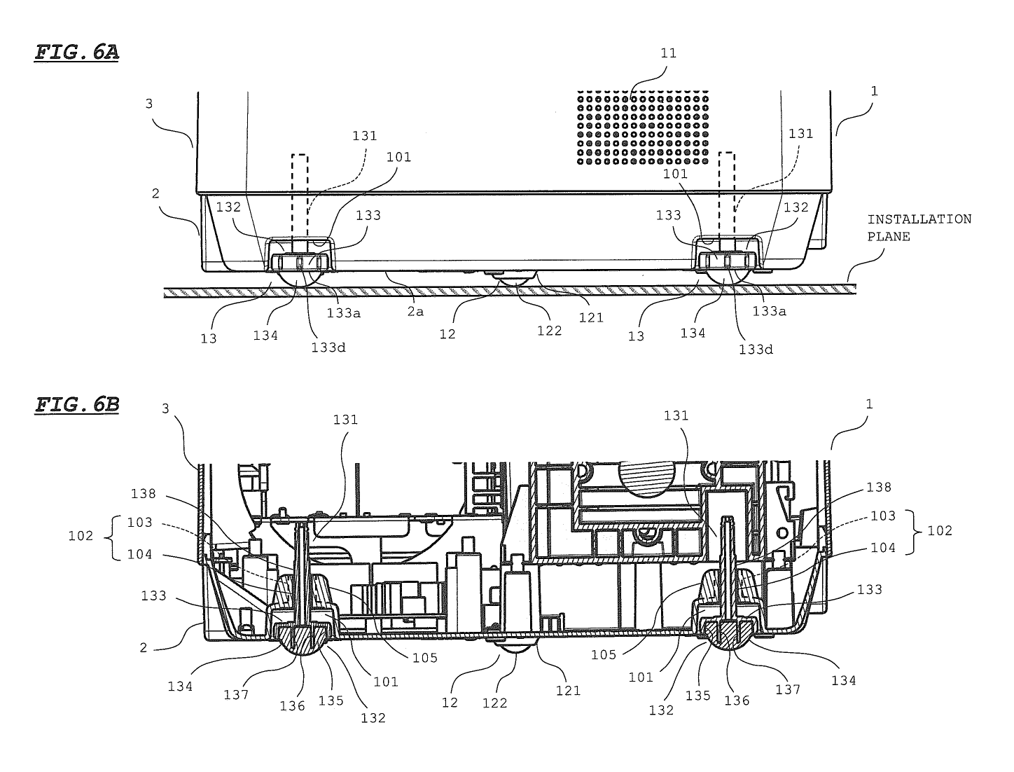

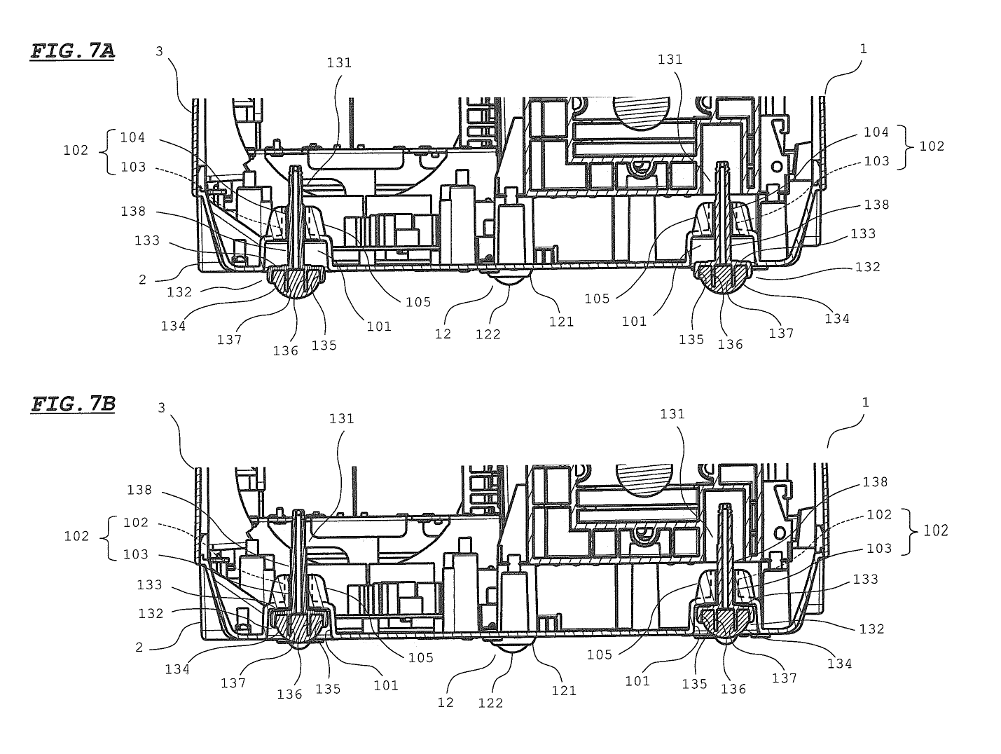

FIGS. 6A to 7B are diagrams for describing an arrangement of the adjustable legs 13 and the fixed leg 12. FIG. 6A is a rear view of essential parts of the projector. FIGS. 6B, 7A and 7B are a cross sectional view of the projector taken along a transverse direction at the position of the adjustable legs 13. FIGS. 6A and 6B show a state that the adjustable legs 13 are set at a reference length position, and that the main body cabinet 1 is placed in parallel to the installation plane. FIG. 7A shows a state that the adjustable legs 13 are expanded from the reference length position, and FIG. 7B shows a state that the adjustable legs 13 are contracted from the reference length position.

The adjustable leg 13 is constituted of the round rod-shaped leg portion 131, and a foot portion 132 formed at a lead end of the leg portion 131. The foot portion 132 is constituted of a tab portion 133, and a contact portion 134 formed on the side of a lower surface 133a of the tab portion 133.

The tab portion 133 is manipulated by the user in expanding or contracting the adjustable leg 13. The tab portion 133 has a cylindrical columnar shape with a small thickness, and the lower surface 133a of the tab portion 133 is formed with a recess portion 135. Further, a cylindrical protrusion 136 is formed in the middle of the recess portion 135. A plurality of projections 133d is formed on the outer surface of the tab portion 133 to facilitate manipulation of the adjustable leg 13 by the user.

The contact portion 134 is made of a rubber material. A base of the contact portion 134 is engaged in the recess portion 135 of the tab portion 133. In the engagement, the protrusion 136 of the tab portion 133 is engaged in a slit portion 137 formed in the contact portion 134. A lead end of the tab portion 133 is substantially formed into a spherical surface. The projector is configured such that the contact portion 134 is contacted with the installation plane when the projector is placed on the installation plane.

The leg portion 131 is integrally formed with the tab portion 133, and has a screw portion 138 formed with male threads. The leg portion 131 is held by the holding portion 102. In the holding, the male threads of the screw portion 138 are engaged with the female threads of the nut 104. The lower surface 133a of the tab portion 133 is aligned in parallel to the bottom surface 2a of the main body cabinet 1 in a state that the leg portion 131 is attached to the holding portion 102.

The fixed leg 12 is constituted of a leg portion 121, and a contact portion 122 formed on a lead end of the leg portion 121. The contact portion 122 is made of a rubber material, and is substantially formed into a spherical surface.

As shown in FIGS. 6A and 6B, when the adjustable legs 13 are set to a reference length position, the tab portion 133 is housed in the recess portion 101 of the main body cabinet 1, with the result that the lower surface 133a of the tab portion 133 and the bottom surface 2a of the main body cabinet 1 are set at the same height as each other with respect to the installation plane. In this state, the height from the lower surface 133a of the tab portion 133 to the lead end of the contact portion 134, and the height of the fixed leg 12 are equal to each other, and the bottom surface 2a of the main body cabinet 1 is aligned in parallel to the installation plane.

When the tab portion 133 is turned in a certain direction from a state that the adjustable leg 13 is set to the reference length position, the leg portion 131 is moved downward by the engaging function between the male threads of the screw portion 138 and the female threads of the nut 104. Then, as shown in FIG. 7A, the projection amount of the leg portion 131 from the bottom surface 2a (the bottom surface of the recess portion 101) of the main body cabinet 1 is increased, with the result that the adjustable leg 13 is expanded.

On the other hand, when the tab portion 133 is turned in a direction opposite to the certain direction from a state that the adjustable leg 13 is set to the reference length position, the leg portion 131 is moved upward. Then, as shown in FIG. 7B, the projection amount of the leg portion 131 from the bottom surface 2a (the bottom surface of the recess portion 101) of the main body cabinet 1 is decreased, with the result that the adjustable leg 13 is contracted. When the adjustable leg 13 is brought to a maximally contracted state, the lead end of the contact portion 134 is slightly projected from the recess portion 101 of the main body cabinet 1.

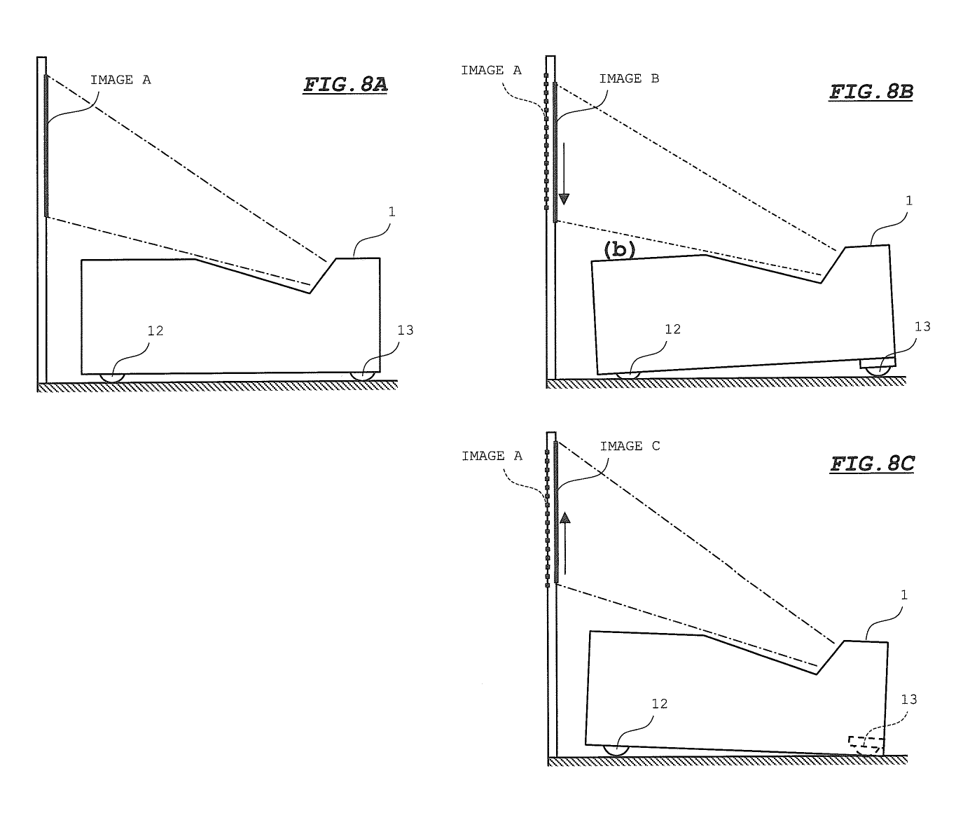

FIGS. 8A to 8C are diagrams for describing a movement of the position of an image when the adjustable legs 13 are expanded and contracted.

In the case where the user wishes to lower the position of a projected image from a state that the main body cabinet 1 is placed in parallel to the installation plane, as shown in FIG. 8A, the user expands the adjustable legs 13 (see FIG. 7A). Then, as shown in FIG. 8B, the main body cabinet 1 is inclined to such a position that the front portion thereof is lowered (in other words, the portion of the main body cabinet 1 on the side of the projection port 4 is raised). Then, the projected image is shifted downward (in other words, the projected image is changed from the state of the image A to the state of the image B).

On the other hand, in the case where the user wishes to raise the position of a projected image from a state that the main body cabinet 1 is placed in parallel to the installation plane, the user contracts the adjustable legs 13 (see FIG. 7B). Then, as shown in FIG. 8C, the main body cabinet 1 is inclined to such a position that the front portion thereof is raised (in other words, the portion of the main body cabinet 1 on the side of the projection port 4 is lowered). Then, the projected image is shifted upward (in other words, the projected image is changed from the state of the image A to the state of the image C).

In the case where the user wishes to return the projector from the state that the main body cabinet 1 is inclined, as shown in FIGS. 8B, 8C to the state that the main body cabinet 1 is placed in parallel to the installation plane as shown in FIG. 8A, the user turns each tab portion 133 to expand or contract the adjustable legs 13 to a degree that the lower surface 133a of the tab portion 133 is set to the same height as the height of the bottom surface 2a of the main body cabinet 1. Thus, in the embodiment, the user is allowed to easily and accurately return the main body cabinet 1 to a state in parallel to the installation plane.

Further, in this embodiment, since the recess portion 101 of the main body cabinet 1 is opened outside toward the rear surface of the main body cabinet 1, the user can easily check whether the lower surface 133a of the tab portion 133 is set to the same height as the height of the bottom surface 2a of the main body cabinet 1 by viewing the projector from the rear side. Thus, this arrangement is further advantageous in returning the main body cabinet 1 to a state in parallel to the installation plane by the user.

Furthermore, in this embodiment, since the lower surface 133a of the tab portion 133 is utilized as an index, there is no need of providing a member serving as an index on the leg portion 132.

In addition, in this embodiment, since the contact portion 134 is made of a rubber material, the adjustable leg 13 is less likely to slip over the installation plane. Thus, there is no or less likelihood that the main body cabinet 1 placed on the installation plane may be inadvertently moved.

The embodiment of the invention has been described as above. However, the invention is not limited to the foregoing embodiment. Further, the embodiment of the invention may be changed or modified in various ways other than the above, as necessary, as far as such changes and modifications do not depart from the scope of the claims of the invention hereinafter defined.

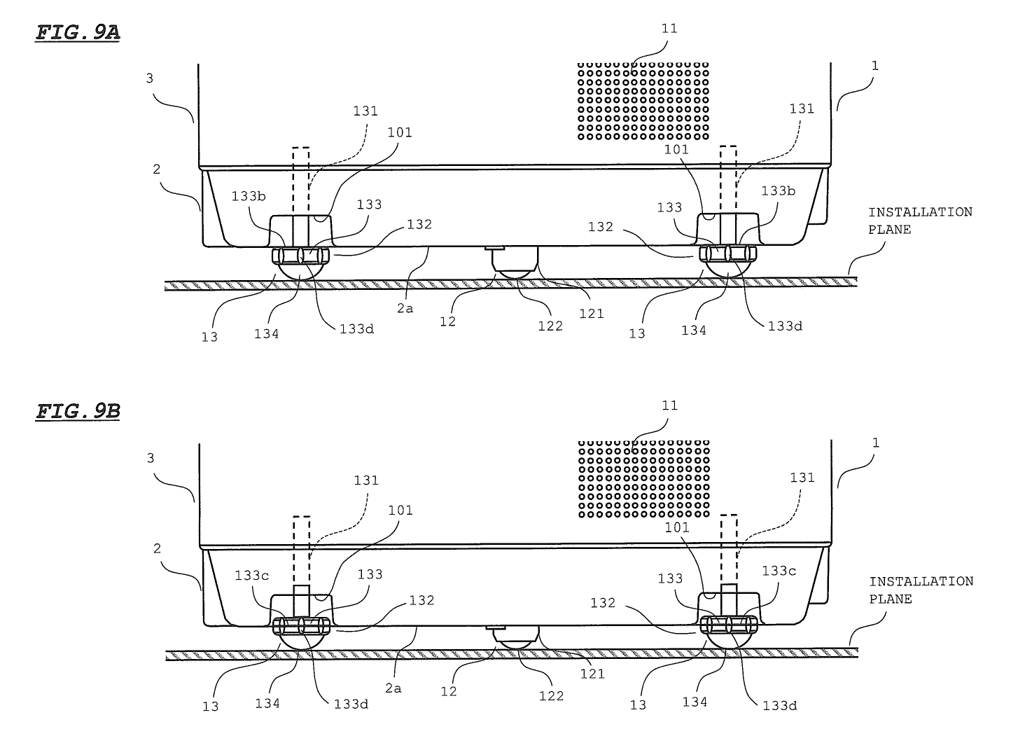

For instance, in this embodiment, the projector is configured such that the main body cabinet 1 is placed in parallel to the installation plane when the lower surface 133a of the tab portion 133 is set to the same height as the height of the bottom surface 2a of the main body cabinet 1. In other words, the lower surface 133a of the tab portion 133 is utilized as an index for placing the main body cabinet 1 in parallel to the installation plane. The embodiment, however, is not limited to the above. For instance, as shown in FIG. 9A, the projector may be configured such that the main body cabinet 1 is placed in parallel to the installation plane when an upper surface 133b of the tab portion 133 is set to the same height as the height of the bottom surface 2a of the main body cabinet 1. In other words, the upper surface 133b of the tab portion 133 may be utilized as an index for placing the main body cabinet 1 in parallel to the installation plane. In this case, the upper surface 133b of the tab portion 133 is aligned in parallel to the bottom surface 2a of the main body cabinet 1. With the above modification, there is no need of providing an index, as with the case that the lower surface 133a of the tab portion 133 serves as an index.

Although the following modification requires a member serving as an index, as shown in FIG. 9B, the projector may be configured such that a line 133c in parallel to the bottom surface 2a of the main body cabinet 1 is formed as the index on the outer surface of the tab portion 133, and that the main body cabinet 1 is placed in parallel to the installation plane when the line 133c is set to the same height as the height of the bottom surface 2a of the main body cabinet 1.

In the case where the arrangement as shown in FIGS. 9A, 9B is adopted, as shown in FIGS. 9A, 9B, the height of the leg portion 121 of the fixed leg 12 is newly set in accordance with the height of the adjustable legs 13.

Further alternatively, the adjustable legs 13 may be configured such that a specific one of the projections 133d of the tab portion 133 is positioned at a center position of the tab portion 133, when viewed from a rear side of the projector, when the main body cabinet 1 is placed in parallel to the installation plane. With the modification, it is easy to identify the position of the adjustable legs 13 where the main body cabinet 1 is placed in parallel to the installation plane. In the modification, it is desirable to change the shape of a specific one of the projections 133d, or color the projection 133d so that the projection 133d serving as an index is identifiable from the other projections 133d.

Further, in this embodiment, since the recess portion 101 of the main body cabinet 1 is configured to be opened outside toward the rear surface of the main body cabinet 1. The embodiment is not limited to the above. Alternatively, the recess portion 101 may be opened outside toward the left and right surfaces of the main body cabinet 1. Further alternatively, the recess portion 101 may be opened outside toward the rear surface and the left and right surfaces (corner portions) of the main body cabinet 1. Specifically, as far as the recess portion 101 is opened outside toward a side surface (such as a rear surface, a left surface or a right surface) of the main body cabinet 1, the recess portion 101 may be opened outside toward any side surface.

Further, in this embodiment, a DMD is used as an imager constituting the imager unit 15. Alternatively, a liquid crystal panel may be used.

Furthermore, in this embodiment, the lamp unit 14 having a light source lamp is used. Alternatively, a light source other than the lamp light source, such as a laser light source or an LED light source may be used.

The embodiment of the invention may be changed or modified in various ways as necessary, as far as such changes and modifications do not depart from the scope of the claims of the invention.

What is claimed is:

1. A projection display device, comprising
a main body cabinet; and
an adjustable leg which is disposed on a bottom surface of the main body cabinet, and adjusts an inclination of the main body cabinet, wherein
the adjustable leg includes a leg portion whose projection amount from the bottom surface is changed, and a foot portion which is formed at a lead end of the leg portion and is contacted with an installation plane of the projection display device, the adjustable leg being expandable and contractible from a reference length position at which the main body cabinet is placed in parallel to the installation plane,
the bottom surface of the main body cabinet has a recess portion which is configured so that the foot portion going in and out of the recess portion as the adjustable leg is contracted and expanded, and
the foot portion has an index portion which is set to the same height as the height of the bottom surface with respect to the installation plane, when the adjustable leg is positioned at the reference length position.

2. The projection display device according to claim 1, wherein
the recess portion is opened outside toward a side surface of the main body cabinet so that a relative relation between the index portion and the bottom surface is viewable.

3. The projection display device according to claim 2, wherein
the foot portion includes a tab portion manipulatable in expanding or contracting the adjustable leg, and
a lower surface of the tab portion is aligned in parallel to the bottom surface of the main body cabinet, the lower surface serving as the index portion.

4. The projection display device according to claim 2, wherein
the foot portion includes a tab portion manipulatable in expanding or contracting the adjustable leg, and
an upper surface of the tab portion is aligned in parallel to the bottom surface of the main body cabinet, the upper surface serving as the index portion.

5. The projection display device according to claim 1, wherein
the foot portion has a contact portion which is contacted with the installation plane, and
the contact portion is made of a rubber material.
